(19) United States
(12) Patent Application Publication
(10) Pub. No.: US 2008/0256581 A1
(43) Pub. Date: Oct. 16, 2008

(54) Apparatus and Method for Interactive Multimedia Service in Access Network

(76) Inventors: Byung-Tak Lee, Kyungki-do (KR); Sung-Yong Lee, Gangwon-do (KR); Ho-Young Song, Daejeon (KR); Bong Tae Kim, Daejeon (KR)

Correspondence Address: LAHIVE & COCKFIELD, LLP;FLOOR 30, SUITE 3000, ONE POST OFFICE SQUARE, BOSTON, MA, 02109, US

(21) Appl. No.: 12/066,444

(22) PCT Filed: Nov. 30, 2006
(86) PCT No.: PCT/KR06/05127

§ 371 Date: Mar. 11, 2008

(30) Foreign Application Priority Data
Dec. 8, 2005 (KR) 10-2005-0119146
Jun. 7, 2006 (KR) 10-2006-0050992

(51) Int. Cl. H04N 7/173

(52) U.S. Cl. 725/86; 725/93; 725/100

(57) ABSTRACT

A system and method for providing an interactive multimedia service to a user in an access network are provided. The system includes a multimedia service providing server and a user terminal. The multimedia service providing server creates multimedia information requested by a user terminal, processes the created multimedia information, and manages a corresponding communication channel to allow a predetermined user terminal to receive the processed multimedia information. The user terminal transmits inputted user multimedia information to the multimedia service providing server through the access network and receives the multimedia information transmitted from the multimedia service providing server through the access network.

### TECHNICAL FIELD

The present invention relates to a system and method for providing an interactive multimedia service to a user in an access network, and more particularly, to a system and method for providing an interactive multimedia service in an access network in order to enable a user of an access network to receive various interactive multimedia services such as a web service, a game, a messenger, a video telephone and a virtual environment based on a multimedia input with a minimum configuration of a terminal.

That is, the present invention enables a user to receive audio/video/data services using a typical broadcasting receiving terminal by performing a upstream transmission for transmitting multimedia information through an IP connection or a RF channel at a user side, and receiving multimedia information of a user, processing the multimedia information using an application program, allocating an IP connect or a RF channel to a user corresponding to a channel managing server, and performing a downstream-transmission for transmitting the processed multimedia information based on a typical broadcasting protocol such as an IP broadcasting or a RF broadcasting at a service server of a central office such as a broadcasting station.

### BACKGROUND ART

The simplest conventional method for providing a multimedia service in an access network is a method for transmitting audio and video information to a user through a downstream according to a typical broadcasting protocol such as IP broadcasting and RF broadcasting from a central station. This method has advantages of a simple structure and a less cost. However, it is not suitable for the interactive multimedia service due to the limitation of receiving input from a user.

Interactivedata broadcasting is another conventional method for providing a multimedia service. The conventional interactive data broadcasting provides the interactive multimedia service as follows. A central office transmits audio and video information to a user through a downstream as a form of IP broadcasting or RF broadcasting and sends application codes and data such as JAVA or XML to a user. The user terminal performs a corresponding multimedia application program to receive the interactive multimedia service.

Since the conventional interactive data broadcasting requires a user terminal to perform a corresponding application program, the hardware or software of the user terminal have become complicated, and the manufacturing cost thereof increases as the multimedia services have become diversealthough an international standard for middleware such as MHP, OCAP and ACAP has been in progress.

Virtual network computing is still another conventional method for providing a multimedia service. In the virtual network computing, a central office includes a dedicated server to perform an application program, and a user has a simple client with an input console such as a keyboard and a pointing device and an output display. The server and the client are connected through a network, and they communicate each other using a dedicated protocol to exchange a client's input console information and a server's display information.

Such a virtual network computing was mainly used in remote-control between computers and monitoring computers. The virtual network computer controls a remote server based on a user's console information in one-to-one manner. However, the typical IP broadcasting or the RF broadcasting that provide a service to a plurality of users in an access network is a one-to-multipoint structure, and a user's multimedia information must be transfer to a central office in order to provides an interactive multimedia service. Therefore, the virtual network computing is not sufficient to provide the interactive multimedia service in an access network.

### DISCLOSURE OF INVENTION

### Technical Problem

An object of the present invention is to provide a system and method for providing an interactive multimedia service in an access network in order to enable a user of an access network to receive various interactive multimedia services such as a web service, a game, a messenger, a video telephone and a virtual environment based on a multimedia input with a minimum configuration of a terminal.

### Technical Solution

According to an aspect of the present invention, there is provided a system for providing interactive multimedia services to at least one of user terminals, including: a service server for transmitting interactive multimedia service availability information to each of the user terminals based on set registration information of the user terminals and creating multimedia information requested by a user terminal capable of using the interactive multimedia services; a data processing server for receiving user multimedia information transmitted from the user terminal to provide the received user multimedia information to the service server and processing the created multimedia information at the service server into data suitable for the access network; and a channel management server for managing communication channels with the access network to allow the pre-determined user terminal to receive the processed multimedia information from the data processing server and to transmit the user multimedia information transmitted from the predetermined user terminal to the data processing server.

According to another aspect of the present invention, there is provided a user terminal for communicating with a service server through an access network to receive interactive multimedia services, the user terminal including: a multimedia information receiving unit for receiving multimedia availability information downstream transmitted from the service server through the access network over an allocated channel and multimedia information requested by a user; and a multimedia information transmitting unit for transmitting the multimedia information selected or inputted by the user based on the received multimedia availability information to the service server over the allocated IP or RF channel to perform upstream transmission to the service server.

According to further another aspect of the present invention, there is provided a method of providing an interactive multimedia service between a service server and a user terminal in an access network, the method including the steps of: a) at the service server, transmitting interactive multimedia service availability information to a user terminal based on set registration information of user terminals through an access network; b) at a least one of user terminals that receives the interactive multimedia service information, transmitting inputted multimedia information to the service server through an access network if the user terminal selects one of service information and inputs the user multimedia information; and c) at the service server, determining whether the user terminal is capable of receiving a predetermine multimedia service according to user information and network information included in the received user multimedia information, and creating corresponding multimedia information according to the received user multimedia information and transmitting the created multimedia information to a corresponding user terminal through an access network.

According to the still further another aspect of the present invention, there is provided a method of transmitting and receiving multimedia information at a user terminal capable of communicating with a service server for receiving an interactive multimedia service through an access network, the method including the steps of: a) receiving multimedia service availability information that is downstream transmitted from the service server through an access network over an allocated channel; b) transmitting multimedia information, which is selected among the received multimedia service availability information by a user or inputted from a user, to the service server through the allocated channel in order to upstream transmit the multimedia information to the server; and c) processing corresponding multimedia information if corresponding multimedia information requested by the user is received from the service server.

### Advantageous Effects

According to the prevent invention, the user can perform upstream transmission for transmitting the multimedia information through the IP connection or RF channel. Moreover, the service server receives user's multimedia information and processes the multimedia information using a corresponding application program. The channel management server uniquely allocates the IP connection or RF channel to the corresponding user terminal 500 and perform downstream transmission in the IP or RF broadcast mode that is a typical broadcasting protocol so as to allow the user to receive audio and video services through the user terminal 500 generally used for receiving a broadcast and thus to make the interactive multimedia services possible. Therefore, the user of the access network can receive various interactive multimedia services such as a web service, a game, a messenger, a video telephone and a virtual environment based on a multimedia input.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram illustrating a network connection and an internal configuration of a system for providing an interactive multimedia service in an access network according to an embodiment of the present invention; and

FIG. 2 is a flowchart illustrating the two-way data flow of a system for providing an interactive service in an access network according to an embodiment of the present invention.

### BEST MODE FOR CARRYING OUT THE INVENTION

Reference will now be made in detail to the preferred embodiments of the present invention, examples of which are illustrated in the accompanying drawings.

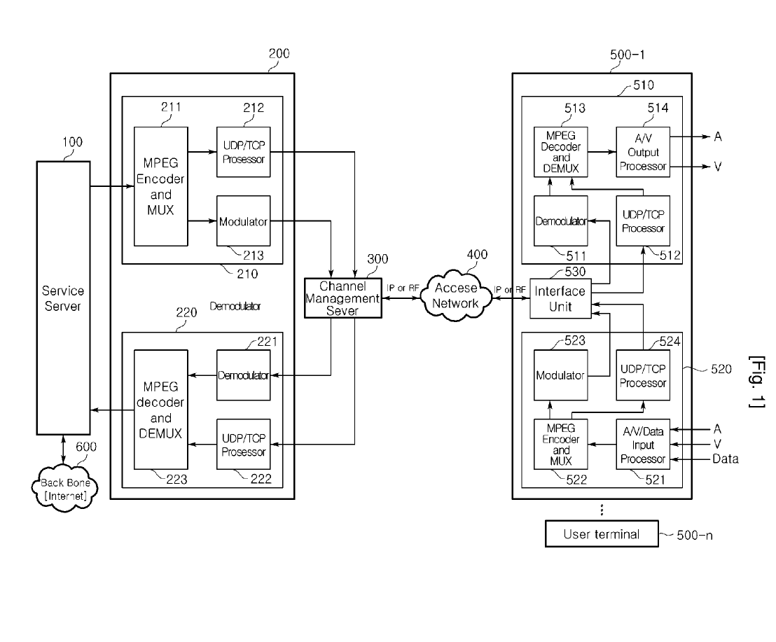

FIG. 1 is a block diagram illustrating a network connection and an internal configuration of a system for providing an interactive multimedia service in an access network according to an embodiment of the present invention.

As shown in FIG. 1, the system for providing an interactive multimedia service in an access network includes a service server 100, a data processing server 200, a channel management server 300, and user terminals 500-1 to 500-n. The channel management server 300 and the user terminals 500-1 to 500-n are connected to each other through an access network 400. The access network 400 may include an IP network and an RF network.

The data processing server 200 includes an MPEG transmitting unit 210 and an MPEG receiving unit 220. The MPEG transmitting unit 210 includes an MPEG encoder and MUX 211, a UDP/TCP processor 212, and a modulator 213. The MPEG receiving unit 220 includes an MPEG decoder and DEMUX 223, a UDP/TCP processor 222, and a demodulator 221.

Each of the user terminals 500 to 500-n is connected to the channel management server 300 through the access network 400 and includes an MPEG receiving unit 510, an MPEG transmitting unit 520, and an interface unit 530.

The MPEG receiving unit 510 of the user terminal 500-1 includes an MPEG decoder and DEMUX 513, a UDP/TCP processor 512, a demodulator 511, and an audio/video (A/V) output processor 514. The MPEG transmitting unit 520 of the user terminal 500-1 includes an A/V/data input processor 521, an MPEG encoder and MUX 522, a UDP/TCP processor 524, and a modulator 523.

The A/V/data input processor 521 of the MPEG transmitting unit 520 in the user terminal 500-1 digitalizes audio and video information inputted from a user, creates data for console information and user channel information, and provides the digitalized audio and video information and the created data to the MPEG encoder and MUX 522, where the console information includes information about a keyboard, a pointing device, a joystick, a remote controller, etc. and the user channel information includes information about an IP address, a port number, a personalized RF channel number, etc.

The MPEG encoder and MUX 522 encodes the audio and video information, the console information, and the user channel information inputted from the A/V/data input processor 521, multiplexes the encoded data, and provides the multiplexed data to the UDP/TCP processor 524 if the access network 400 is in an IP connection state, or to the modulator 523 if the access network 400 is in an RF channel connection state.

If the access network 400 is in the IP connection state, the UDP/TCP processor 524 converts the multiplexed upstream data (audio/video/console/channel information) provided from the MPEG encoder and MUX 522 into a UDP or TCP data format that is a data transmission format for the IP network, and provides the converted data to the interface unit 530.

On the other hand, if the access network 400 is the RF channel connection state, the modulator 523 modulates the multiplexed upstream data (audio/video/console/channel information) provided from the MPEG encoder and MUX 522 and provides the modulated data to the interface unit 530. Herein, the modulator 523 may use at least one of QAM, VSB, OFDM, and QPSK modulation schemes.

The interface unit 530 performs upstream transmission for the data provided from the MPEG transmitting unit 520 to the channel management server 300 in accordance with the connection state of the access network 400.

In addition, the interface unit 530 interfaces the downstream multimedia data received through the access network 400 to the MPEG receiving unit 510 of the user terminal 500-1. At this time, if the connection with the access network 400 is in the RF connection state, the interface unit 530 provides the received downstream data to the demodulator 511 of the MPEG receiving unit 510. On the other hand, if the connection with the access network 400 is in the IP connection state, the interface unit 530 provides the received downstream data to the UDP/TCP processor 512 of the MPEG receiving unit 510.

When the connection with the access network 400 is in the RF connection state, the demodulator 511 of the MPEG receiving unit 510 in the user terminal 500-1 demodulates the downstream multimedia data received from the interface unit 530 and provides the demodulated data to the MPEG decoder and DEMUX 513. Herein, the demodulator 511 may use at least one of QAM, VSB, OFDM, and QPSK demodulation schemes.

On the other hand, when the connection with the access network 400 is in the IP connection state, the UDP/TCP processor 512 of the MPEG receiving unit 510 converts the UDP or TCP format of the downstream multimedia data received from the interface unit 530 and provides the converted multimedia data to the MPEG decoder and DEMUX 513.

The MPEG decoder and DEMUX 513 demultiplexes the multimedia data received from the demodulator 511 or the UDP/TCP processor 512, decodes the demultiplexed multimedia data, and outputs the decoded multimedia data (audio and video data) to the A/V output processor 514.

The A/V output processor 514 processes the audio and video data outputted from the MPEG decoder and DEMUX 513 and outputs the processed audio and video data to a speaker and a display device so that the user can hear and see the output audio and video data.

The channel management server 300 in a central office allows registered user terminals 500 only to receive a multimedia service through IP broadcasting or RF broadcasting via the access network 400. In order to solve a problem that may arise because the IP or RF broadcasting via the access network 400 is a point-to-multipoint structure, the channel management server 300 controls the network connection by determining the subscriber's access authority and availability of the service server 100 based on the user channel information such as an IP address, a port number, a personalized RF channel number when the MPEG transmitting unit 520 of the pre-determined user terminal 500-1 attempts to perform upstream transmission to the MPEG receiving unit 220 of the data processing server 200.

In addition, the channel management server 300 controls the network connection by uniquely allocating the IP connection or RF channel based on the user channel information such as an IP address, a port number, a personalized RF channel number when the MPEG transmitting unit 210 of the data processing server 200 attempts to perform downstream transmission for the multimedia information to the MPEG receiving unit 510 of the user terminal 500-1, so that only the corresponding subscriber can receive the IP or RF broadcast.

The MPEG receiving unit 220 of the data processing server 200 receives the upstream multimedia data transmitted from the MPEG transmitting unit 520 of the user terminal 500-1 through the access network 400.

The demodulator 221 of the MPEG receiving unit 220 demodulates the upstream data received from the channel management server 300, that is, user multimedia data transmitted from the user terminal 500-1, and provides the demodulated multimedia data to the MPEG decoder and DEMUX 223. Herein, the demodulator 221 may use at least one of QAM, VSB, OFDM, and QPSK demodulation schemes. The upstream data transmitted from the user terminal 500-1 may include audio information, video information, console information (for example, about a keyboard, a pointing device, a joystick, a remote controller, etc.), and user channel information (for example, about an IP address, a port number, a personalized RF channel number, etc.).

The UDP/TCP processor 222 of the MPEG receiving unit 220 converts the UDP or TCP format of the upstream user multimedia information received through the channel management server 300 and provides the converted multimedia data to the MPEG decoder and DEMUX 223.

The MPEG decoder and DEMUX 223 demultiplexes the MPEG multimedia data received through the demodulator 221 or the UDP/TCP processor 222 in accordance with the connection state with the access network 400, decodes the demultiplexed multimedia data, and provides the decoded audio/video/data to the service server 100.

In the data processing server 200, the MPEG transmitting unit 210 that transmits the multimedia information to the user performs downstream transmission for transmitting the audio, video, and data processed by the service server 100 to the user terminal 500-1. More specifically, the MPEG encoder and MUX 211 of the MPEG transmitting unit 210 encodes the audio, video, and data provided from the service server 100, multiplexes the encoded data, and provides the multiplexed data to the UDP/TCP processor 212 if the access network 400 is in an IP connection state, or to the modulator 213 if the access network 400 is in an RF channel connection state.

If the access network 400 is in the IP connection state, the UDP/TCP processor 212 converts the multiplexed downstream multimedia data provided from the MPEG encoder and MUX 211 into a UDP or TCP data format that is a data transmission format for the IP network, and transmits the converted data to the user terminal 500-1 through the channel management server 300 and the access network 400.

On the other hand, if the access network is the RF channel connection state, the modulator 213 modulates the multiplexed downstream multimedia data provided from the MPEG encoder and MUX 211 and transmits the modulated data to the user terminal 500-1 through the channel management server 300 and the access network 400. Herein, the modulator 213 may use at least one of QAM, VSB, OFDM, and QPSK modulation schemes.

The service server 100 receives the upstream multimedia data transmitted from the user terminal 500-1, processes the multimedia data with installed application programs, and generates multimedia data to transmit through downstream.

More specifically, the service server 100 receives the user audio, video, and data that were transmitted from the user terminal 500-1 via the access network 400 through the MPEG receiving unit 220 of the data processing server 200, executes various multimedia application programs based on multimedia input data, such as web service, game, messenger, video telephony, and virtual reality programs, and transmits the output audio, video, and data to the MPEG transmitting unit 210. Then the MPEG transmitting unit 210 processes the multimedia data with the aforementioned method and transmits the processed multimedia data to the corresponding user terminal 500-1 through the access network 400.

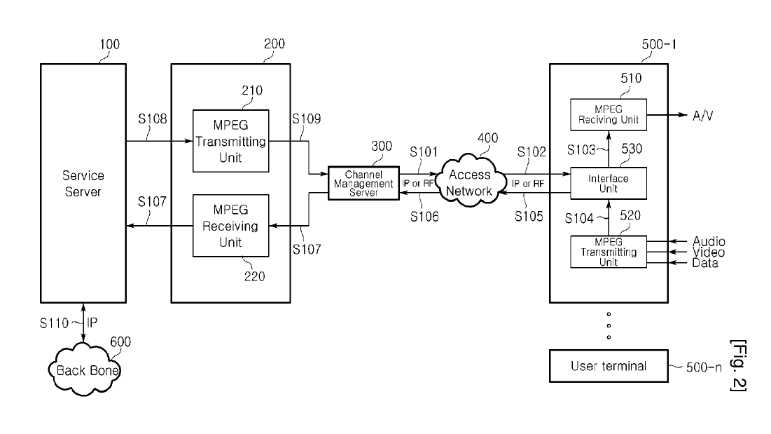

The operations of a system for providing an interactive service in an access network according to an embodiment of the present invention will now be described with reference to FIG. 2.

FIG. 2 is a flowchart illustrating the two-way data flow of a system for providing an interactive service in an access network according to an embodiment of the present invention.

As shown in FIG. 2, a channel management server 300 informs all user terminals 500 to 500-n that are connected to an access network using the predetermined IP addresses, port numbers, and RF channel numbers of the existence and service kinds of a service server in an IP connection or RF channel mode to the access network 400 at steps S101.

All the user terminals 500 to 500-n connected to the access network 400 receives the information of the existence and service kinds of the service server 100 in the IP connection or RF channel mode at step S102.

The user terminal 500-1 recognizes the existence and service kinds of the service server 100 through audio and video output from the MPEG receiving unit 510, such as in form of an electronic program guide, at step S103.

When the subscriber connected to the access network 400 selects a service by the user terminal 500-1 and inputs user audio, video, and data such as console information and user channel information at step S104, an MPEG transmitting unit 520 of the corresponding user terminal 500-1 performs upstream transmission for the user multimedia information to the channel management server 300 through the access network 400 in the IP connection or RF channel mode at step S105.

Thus, the channel management server 300 receives the user multimedia information in the IP connection or RF channel mode, determines the subscriber's access authority and availability of the service server 100 based on the user channel information such as an IP address, a port number, a personalized RF channel number, and control the network connection at step S106.

The multimedia information of the user whose network connection has been accepted is provided to the service server 100 through the MPEG receiving unit 220 of a data processing server 200 at step S107.

The service server 100 executes a corresponding multimedia application program such as web service, game, messenger, video telephony, and virtual reality programs based on multimedia data inputted from the MPEG receiving unit 220 of the data processing server 200 and provides the output audio, video, and data to the MPEG transmitting unit 210 of the data processing server 200 at step S108.

The MPEG transmitting unit 210 of the data processing server 200 processes the multimedia data provided from the service server 100 and transmits the processed multimedia data to the corresponding user terminal 500-1 through the channel management server 300 at step S109. The channel management server 300 controls the network connection by uniquely allocating the IP connection or RF channel based on the user channel information such as an IP address, a port number, a personalized RF channel number when performing downstream transmission for the multimedia data to the MPEG receiving unit 510 of the user terminal 500-1 so that only the corresponding subscriber can receive the IP or RF broadcast.

The channel management server 300 performs downstream transmission for transmitting the multimedia information in the IP connection or RF channel mode or transmits the multimedia information to a backbone network configured with the Internet if necessary at step S110.

When the user wants to terminate the interactive multimedia service, the channel manage server 300 properly controls the network connection based on the user multimedia input information.

As described above, in an embodiment of the prevent invention, the data processing server 200 and the user terminal 500-1 each have the MPEG transmitting units 210 and 520 and the MPEG receiving units 220 and 510 so that the user can receive interactive multimedia services in the access network, and the service server 100 and the channel management server 300 are included so that the user can perform upstream transmission for transmitting the multimedia information through the IP connection or RF channel. Moreover, the channel management server 300 uniquely allocates the IP connection or RF channel to the corresponding user terminal 500-1 and perform downstream transmission in the IP or RF broadcast mode that is a typical broadcasting protocol so as to allow the user to receive audio and video services through the user terminal 500-1 generally used for receiving a broadcast and thus to make the interactive multimedia services possible.

It will be apparent to those skilled in the art that various modifications and variations can be made in the present invention. Thus, it is intended that the present invention covers the modifications and variations of this invention provided they come within the scope of the appended claims and their equivalents.

1. A system for providing interactive multimedia services to at least one of user terminals through an access network, the system comprising:
a multimedia service providing server for creating multimedia information requested by a user terminal, processing the created multimedia information, and managing a corresponding communication channel to allow a predetermined user terminal to receive the processed multimedia information; and
a user terminal for transmitting inputted user multimedia information to the multimedia service providing server through the access network and receiving the multimedia information transmitted from the multimedia service providing server through the access network.

2. The system of claim 1, wherein the access network includes at least one of an IP communication network and an RF communication network.

3. A system for providing interactive multimedia services to at least one of user terminals, comprising:
a service server for transmitting interactive multimedia service availability information to each of the user terminals based on set registration information of the user terminals and creating multimedia information requested by a user terminal capable of using the interactive multimedia services;
a data processing server for receiving user multimedia information transmitted from the user terminal to provide the received user multimedia information to the service server and processing the created multimedia information at the service server into data suitable for the access network; and
a channel management server for managing communication channels with the access network to allow the predetermined user terminal to receive the processed multimedia information from the data processing server and to transmit the user multimedia information transmitted from the predetermined user terminal to the data processing server.

4. The system of claim 3, wherein the data processing server includes:
a multimedia information receiving unit for receiving the multimedia information transmitted from the user terminal through the access network over an IP or RF channel allocated by the channel management server; and
a multimedia information transmitting unit for transmitting the processed multimedia information to the access network over an IP or RF channel allocated by the channel management server in order to transmit the multimedia information to the user terminal through downstream.

5. The system of claim 4, wherein the multimedia information receiving unit includes:
a demodulator for demodulating upstream multimedia data received from the channel management server in a set demodulation scheme if a connection state with the access network is an RF channel connection state;
a UDP/TCP processor for processing a UDP or TCP format of the user multimedia information received through upstream from the channel management server if a connection state with the access network is an IP connection state; and
a decoder and DEMUX for compressed decoding the multimedia data received through the demodulator or the UDP/TCP processor depending on the connection state with the access network, demultiplexing the decoded multimedia data, and decoding the demultiplexed multimedia data to provide audio/video/data to the service server.

6. The system of claim 5, wherein the set demodulation scheme in the demodulator is at lease one of QAM, VSB, OFDM and QPSK.

7. The system of claim 4, wherein the multimedia information transmitting unit includes:
an encoder and MUX for compressing and encoding the multimedia data transmitted from the service server and multiplexing the encoded multimedia data to output the multiplexed multimedia data;
a modulator for modulating the multimedia data outputted from the encoder and MUX in a set modulation scheme to provide the modulated multimedia data to the channel management server if a connection state with the access network is an RF channel connection state; and
a UDP/TCP processor for converting the multimedia data transmitted from the encoder and MUX into a UDP or TCP format to provide the converted multimedia data to the channel management server if a connection state to the access network is an IP connection stat.

8. The system of claim 7, wherein the set modulation scheme in the modulator is at least one of QAM, VSB, OFDM and QPSK.

9. The system of claim 7, wherein the upstream multimedia data includes at least one of audio information, video information, console information including information about a keyboard, a pointing device, a joy stick and a remote, and user channel information including information about an IP address, a port number and a personalized RF channel number.

10. A user terminal for communicating with a service server through an access network to receive interactive multimedia services, the user terminal comprising:
a multimedia information receiving unit for receiving multimedia availability information downstream transmitted from the service server through the access network over an allocated channel and multimedia information requested by a user; and
a multimedia information transmitting unit for transmitting the multimedia information selected or inputted by the user based on the received multimedia availability information to the service server over the allocated IP or RF channel to perform upstream transmission to the service server.

11. The user terminal of claim 10, wherein the multimedia information receiving unit includes:
a demodulator for demodulating downstream multimedia information received from the channel management server in a set demodulation scheme if a connection state with the access network is an RF channel connection state;
a UDP/TCP processor for processing a UDP or TCP format of the downstream multimedia information received through the channel management server if a connection state with the access network is an IP connection state; and
a decoder and DEMUX for compressing and decoding the multimedia data received through the demodulator or the UDP/TCP processor depending on the connection state with the access network, demultiplexing the decoded multimedia data, and decoding the demultiplexed multimedia data to provide audio/video/data to the service server.

12. The user terminal of one of claims 11, wherein the set demodulation scheme in the demodulator is at lease one of QAM, VSB, OFDM and QPSK.

13. The user terminal of claim 10, wherein the multimedia information transmitting unit includes:
an encoder and MUX for encoding the multimedia data inputted from a user and multiplexing the encoded multimedia data to output the multiplexed multimedia data;
a modulator for modulating the multimedia data outputted from the encoder and MUX in a set modulation scheme and transmitting the modulated multimedia data to a multimedia service server through an access network if a connection state with the access network is an RF channel connection state; and
a UDP/TCP processor for converting the multimedia data transmitted from the encoder and MUX into a UDP or TCP format and transmitting the converted UDP/TCP multimedia data to the multimedia service server through the access network if a connection state to the access network is an IP connection state.

14. The user terminal of one of claim 13, wherein the set modulation scheme in the modulator is at least one of QAM, VSB, OFDM and QPSK.

15. The user terminal of one of claim 13, wherein the upstream multimedia data includes at least one of audio information, video information, console information including information about a keyboard, a pointing device, a joy stick and a remote, and user channel information including information about an IP address, a port number and a personalized RF channel number.

16. A method for providing an interactive multimedia service between a multimedia service providing server and a user terminal in an access network, the method comprising the steps of:
a) transmitting interactive multimedia service availability information to each user terminal based on set registration information of a plurality of user terminals
b) determining whether a user terminal is capable of receiving a predetermined interactive multimedia service according to user information and network information included in user multimedia information received from the user terminal
c) creating corresponding multimedia information according to the received user multimedia information, and transmitting the created multimedia information to a user terminal if the user terminal is capable of receiving a service; and
d) transmitting input multimedia information to a service server through an access network if user multimedia information is inputted from a user after receiving interactive multimedia service information from the multimedia service providing server and selecting one of service information at the user.

17. The method of claim 16, wherein the step c) includes the steps of:
c-1) demodulating the upstream multimedia data received from a user terminal according to a set demodulation scheme if a connection state to the access network is a RF channel connection, and processing the user multimedia information upstream received from the user terminal based on a UDP or a TCP if the connection state to the access network is an IP connection; and
c-2) demultiplexing the demodulated multimedia data or the UDP or TCP processed multimedia data depending on the connection state of the access network, and decoding the demultiplexed multimedia data.

18. The method of claim 16, wherein the set registration information of the user terminal includes at least one of information about an IP address of a user terminal, a port and a RF channel number.

19. The method of claim 16, wherein the interactive multimedia service availability information includes EPG (electronic program guide) information.

20. A method of providing an interactive multimedia service between a service server and a user terminal in an access network, the method comprising the steps of:
a) at the service server, transmitting interactive multimedia service availability information to a user terminal based on set registration information of user terminals through an access network;
b) at a least one of user terminals that receives the interactive multimedia service information, transmitting inputted multimedia information to the service server through an access network if the user terminal selects one of service information and inputs the user multimedia information and
c) at the service server, determining whether the user terminal is capable of receiving a predetermine multimedia service according to user information and network information included in the received user multimedia information, and creating corresponding multimedia information according to the received user multimedia information and transmitting the created multimedia information to a corresponding user terminal through an access network.

21. The method of claim 20, wherein the step c) includes the steps of:
c-1) compressing and encoding multimedia data requested from the user terminal and multiplexing and outputting the encoded multimedia data;
c-2) modulating the multiplexed multimedia data according to a set modulation scheme and transmitting the modulated multimedia data through an access network if the connection state to the access network is a RF channel connection; and
c-3) converting the multiplexed multimedia data in a UDP format or a TCP format and transmitting the converted multimedia data to a user terminal through an access network if the connection state to the access network is an IP connection.

22. The method of claim 20, wherein the set registration information of the user terminal includes at least one of information about an IP address of a user terminal, a port and a RF channel number.

23. The method of claim 20, wherein the interactive multimedia service availability information includes EPG (electronic program guide) information.

24. A method of transmitting and receiving multimedia information at a user terminal capable of communicating with a service server for receiving an interactive multi media service through an access network, the method comprising the steps of:
a) receiving multimedia service availability information that is downstream transmitted from the service server through an access network over an allocated channel;
b) transmitting multimedia information, which is selected among the received multimedia service availability information by a user inputted from a user, to the service server through the allocated channel in order to upstream transmit the multimedia information to the server; and
c) processing corresponding multimedia information if corresponding multimedia information requested by the user is received from the service server.

25. The method of claim 24, wherein the step c) includes the steps of:
c-1) demodulating downstream multimedia information transmitted from the service server through the access network if a connection state to the access network is a RF channel connection, or processing downstream multimedia information transmitted from the service server through the access network based on a UDP or a TCP if a connection state to the access network is an IP connection; and
c-2) demultiplexing the processed multimedia data according to the connection state of the access network, decoding the demultiplexed multimedia data, and outputting audio/video/data through an output device.

26. The method of claim 24, wherein the step b) includes the steps of:
b-1) encoding multimedia data inputted from a user and multiplexing the encoded multimedia data;
b-2) modulating the multiplexed multimedia data according to a set modulation scheme, and transmitting the modulated multimedia data to a multimedia service server through an access network if the connection state to the access network is the RF channel connection; and
b-3) converting the multiplexed multimedia data into a UDP format or a TCP format, and transmitting the converted multimedia data to the service server through the access network if the connection state to the access network is the IP connection.
